(19) United States
(12) Patent Application Publication
(10) Pub. No.: US 2009/0129713 A1
(43) Pub. Date: May 21, 2009

(54) Angular Contact Ball Bearing and Joint Assembly for a Robotic Arm

(76) Inventor: Junichi Hattori, Kwana (JP)

Correspondence Address: WENDEROTH, LIND & PONACK, L.L.P., 1030 15th Street, N.W.,, Suite 400 East, Washington, DC, 20005-1503, US

(21) Appl. No.: 11/988,429

(22) PCT Filed: Jul. 12, 2006
(86) PCT No.: PCT/JP2006/313867

§ 371 Date: Jan. 8, 2008

(30) Foreign Application Priority Data
Jul. 13, 2005 (JP) 2005-204417
Jul. 13, 2005 (JP) 2005-204659
Jul. 13, 2005 (JP) 2005-204678
Dec. 19, 2005 (JP) 2005-365135
Dec. 19, 2005 (JP) 2005-365204
Jan. 6, 2006 (JP) 2006-001506

(51) Int. Cl. F16C 33/58; F16C 33/32; F16C 33/66

(52) U.S. Cl. 384/462; 384/513; 384/491; 384/514

(57) ABSTRACT

It is aimed to increase the rigidity of an angular contact ball bearing of the type in which each ball contacts at least one of the raceways at two points, improve the lubricating environment of the balls, reduce the weight of the bearing while maintaining wear resistance and rigidity of the balls, reduce the weight of the bearing while maintaining wear resistance of the balls, improve the radial rigidity and axial rigidity of the bearing in a balanced manner, or to supply a sufficient amount of lubricating oil into an internal area between the two contact points between each ball and the raceway.

A counter portion 7 is formed. With each ball 6 in contact with the raceway at two points, a gap is present between the portion of the bearing ring at the bearing centerline C and each ball 6. The balls 6 may be ceramic balls. A coating for improving wear resistance may be applied to the balls. The contact angle of the contact point close to the bearing center line is set at 15 to 25°, while the contact angle of the contact point remote from the centerline C is set at 40 to 50°.

### TECHNICAL FIELD

The present invention relates to an angular contact ball bearing, and particularly to one that is suitable for supporting a rotary shaft to which moment loads are applied at a low rotational speed.

### BACKGROUND ART

Driving units of which the output shaft is rotated at a low speed not exceeding 100 rpm, such as sprocket driving units in construction machines and joint assemblies for robotic arms, include a driving source and a speed reducer. The output shaft of the speed reducer is rotatably supported through a main bearing disposed between the output shaft and the driving unit. The loading point of such a main bearing is located outside the bearing, so that moment loads are applied thereto. Thus, angular contact rolling bearings are used as such main bearings.

With the above-described devices, it is desired to increase the rigidity of the main bearing against moment loads for accurate attitude control and positioning of the arm or machine.

Conventional angular contact ball bearings are configured to support axial components of moment loads (which are applied to the bearing in one axial direction) with each ball in contact with each of the raceways of the inner and outer rings at one point (see e.g. Patent document 1).

Patent document 1: JP2002-21855A

One way to improve the rigidity of the angular contact ball bearing as disclosed in Patent document 1 is to increase the sizes of the outer ring, inner ring and rolling elements, and/or to increase the number of rolling elements.

But because compactness is required for driving devices for construction machines and joint assemblies for robotic arms, installation space for bearings in these devices is limited.

For this reason, tapered roller bearings, which are higher in rigidity than angular contact ball bearings, were also sometimes used as such main bearings. But tapered roller bearings are more costly than angular contact ball bearings because machining of their raceways and rolling elements is more complicated.

Therefore, in an earlier patent application (JP patent application 2004-005538), which was not open to the public at the time of filing of three of the six applications based on which priority of the present patent application is claimed, i.e. JP patent applications 2005-204417, 2005-204659 and 2005-204678, the applicant proposed an angular contact ball bearing wherein the balls are each in contact with one of the raceways of the inner and outer rings at two points and with the other raceway at least at one point, wherein the two contact points on the above one of the raceways are offset to one axial side from the bearing centerline, and the contact point on the other raceway is offset to the other axial side.

With the angular contact ball bearing disclosed in this earlier patent application, because each ball contacts the one of the raceways at two points, by adjusting the mounting direction of the bearing so as to correspond to the direction of axial loads applied to the bearing in one direction, such axial loads are supported in a dispersed manner according to the contact angles of the above two contact points. Thus, the bearing is less likely to be deformed compared to conventional bearings. That is, the rigidity of the bearing increases. This bearing can support radial loads in the same manner as with conventional bearings because each ball is in contact the other raceway at least at one point.

### DISCLOSURE OF THE INVENTION

### Object of the Invention

Each of the balls of an angular contact ball bearing rotates about the central axis of the bearing while spinning about an axis that passes its center and intersects the nominal line of action at a right angle. Such spinning causes wear and peeling of the balls and raceways.

In particular, with the angular contact ball bearing disclosed in the above earlier patent application, because there is a limit to the machining accuracy of the balls and the above one of the raceways, and because each ball contacts the one of the raceways at two points, the balls tend to spin in a complicated manner.

Such wear and peeling are influenced by the lubricating environment at the contact points. In the angular contact ball bearing disclosed in the above earlier patent application, because the two contact points on the one of the raceways are offset to one axial side from the bearing centerline, lubricant cannot be easily supplied to the above two contact points compared to conventional bearings.

Therefore, a first object of the present invention is to make it easier for lubricant to reach two contact points on one of the raceways that are offset to one axial side from the bearing centerline.

With the angular contact ball bearing disclosed in the above earlier patent application, of which the balls tend to spin in a complicated manner, in view of the rigidity and wear of the balls, it was difficult to reduce the weight of the bearing by reducing the diameter or number of the balls.

It is therefore a second object of the present invention to reduce the weight of the angular contact ball bearing disclosed in the above earlier patent application while maintaining the rigidity and wear resistance of the balls.

If the angular contact ball bearing disclosed in the above earlier application is mounted to the output shaft of a speed reducer in a joint assembly for moving an arm, in view of the inertia that acts on the arm joint, the weight of the bearing should be as small as possible.

But with the angular contact ball bearing disclosed in the above earlier patent application, of which the balls tend to spin in a complicated manner, in view of wear of the balls, it was difficult to reduce the weight of the bearing by reducing the diameter or number of the balls.

A third object of the invention is therefore to reduce the weight of the angular contact ball bearing disclosed in the above earlier patent application, while maintaining the wear resistance of the balls.

With the angular contact ball bearing disclosed in the above earlier patent application, each ball is in contact with at least one of the raceways of the inner and outer rings at two points having different contact angles from each other to disperse the contact load between the balls and the raceways, thereby reducing their elastic contact deformation. When each ball contacts the raceway at two points having different contact angles from each other, wear tends to develop due to a difference in peripheral speed at the two contact points. But in the case of an angular contact ball bearing used at a low rotational speed, the above peripheral speed difference is small, so that wear poses no problem.

But with an angular contact ball bearing of the type in which each ball contacts at least one of the raceways of the inner and outer rings at two points having different contact angles from each other, if the contact angle α₁ closer to the bearing centerline is large, the radial rigidity against radial loads decreases. If the contact angle α₂ remote from the bearing centerline is small, the axial rigidity against axial loads decreases.

A fourth object of the invention is therefore to ensure radial rigidity and axial rigidity of an angular contact ball bearing in a balanced manner.

Although angular contact ball bearings of the type in which each ball is in contact with at least one of the raceways of the inner and outer rings at two points, such as the angular contact ball bearing disclosed in the above earlier patent application, has high rigidity, because the one raceway is formed of two curved surfaces so that each ball contacts each of the curved surfaces at one point, it is troublesome to form such two curved surfaces having curvatures both in the circumferential and axial directions. This increases the manufacturing cost.

A fifth object of the invention is therefore to reduce the manufacturing cost of a high-rigidity angular contact ball bearing of which each ball is in contact with a raceway at two points.

With the angular contact ball bearing disclosed in the above earlier patent application, due to elastic contact deformation at the contact points, gaps are scarcely present between the raceways and the balls in the internal area between the contact points, so that it is difficult to supply lubricating oil into this internal area. This increases the possibility of wear in this internal area. Also, due to an increased contact area between the balls and the raceways, they tend to slide markedly relative to each other, which increases the possibility of loss of oil film.

A sixth object of the invention is therefore to provide an angular contact ball bearing in which a sufficient amount of lubricating oil can be supplied into the internal area between the two contact points between the respective balls and raceways.

### Means to Achieve the Object

In order to achieve the above first object, the present invention provides an angular contact ball bearing wherein balls are each in contact with one of raceways of an outer ring and an inner ring at two points and in contact with the other raceway at least at one point, characterized in that the contact points on the one of the raceways are offset to one axial side from a bearing centerline, that the contact point on the other of the raceways is offset to an axial side opposite to the one axial side from the bearing centerline, that one of the inner and outer rings formed with the one of the raceways has a counter portion on its axial side opposite to the one axial side, and that with each of the balls in contact with the one of the raceways at the two contact points, a gap is present between the portion of the one of the inner and outer rings at the bearing centerline and each of the balls.

With this arrangement, by forming the counter portion, i.e. a portion having no shoulder, lubricant can flow easily toward the bearing centerline from outside the bearing. Because there exists a gap between the portion of the one of the inner and outer rings at the bearing centerline and each of the balls, the lubricant that has flown into the bearing can readily reach the two contact points on said one of the raceways.

In view of flowability, the lubricant is preferably lubricating oil. Lubrication may be by way of e.g. circulating lubrication or bath lubrication.

As described above, in order to achieve the first object, according to the present invention, because one of the inner and outer rings formed with the one of the raceways has a counter portion on its axial side opposite to the one axial side, and with each of the balls in contact with the one of the raceways at the two contact points, a gap is present between the portion of the one of the inner and outer rings at the bearing centerline and each of the balls, lubricant can readily reach the two contact points on the one of the raceways, which are offset to the one axial side from the bearing centerline.

In order to achieve the second object, according to the present invention, the balls comprise ceramic balls.

With this arrangement, the ceramic balls, typically silicon nitride ceramic balls, are lightweight and high in rigidity and hardness compared to steel balls. Thus, according to the present invention, due to these advantages, it is possible to reduce the diameter and/or number of the balls. This reduces the total weight of the balls, and thus the weight of the entire bearing.

Thus, if a joint assembly for a robotic arm is formed of a speed reducer to which the driving force for driving the arm is applied, and the angular contact ball bearing according to the present invention, which is mounted to the output shaft of the speed reducer, it is possible to reduce the weight and size of the arm joint. By increasing its rigidity and reducing inertia that acts on the arm joint, it is possible to improve the positioning accuracy and response to control.

In order to achieve the third object, the present invention is characterized in that a coating for improving wear resistance is formed on the balls.

With this arrangement, the coating improves the wear resistance of the balls. This makes it possible to correspondingly reduce the diameter and number of the balls, thereby reducing the total weight of the balls and thus the weight of the entire bearing.

Thus, if a joint assembly for a robotic arm is formed of a speed reducer to which the driving force for driving the arm is applied, and the angular contact ball bearing according to the present invention, which is mounted to the output shaft of the speed reducer, it is possible to reduce the weight and size of the arm joint. By increasing its rigidity and reducing inertia that acts on the arm joint, it is possible to improve the positioning accuracy and response to control.

In order to achieve the fourth object, the present invention provides an angular contact ball bearing wherein balls are each in contact with respective raceways of an inner ring and an outer ring on opposite sides of a bearing centerline, and wherein the balls are in contact with at least one of the raceways at two contact points having different contact angles from each other, characterized in that the contact angle α₁ at one of the two contact points that is located closer to the bearing centerline than is the other contact point is 15 to 25°, and the contact angle α₂ at the other contact point is 40 to 50°.

The present inventors calculated the elastic contact deformation between the balls and the raceways based on the elastic contact theory, and quantitatively studied the radial rigidity and axial rigidity due to the difference between the contact angles α₁ and α₂. The angular contact ball bearings based on which the above calculation was conducted had an outer diameter of 380 [mm], an inner diameter of 290 [mm], and a width of 40 [mm].

FIG. 16 shows the results of calculation of the radial displacement relative to the radial load when the contact angle α₁ is changed with the contact angle α₂ kept at a constant value of 450. FIG. 17 shows the results of calculation of the axial displacement relative to the axial load when the contact angle α₂ is changed with the contact angle α₁ kept at a constant value of 15°.

The graphs of FIGS. 16 and 17 show the results of calculation in comparison with the results of calculation for a comparative example in which each ball is in contact with each raceway at one point at a contact angle α of 30°. With the one-point contact arrangement, both radial and axial displacements are significantly larger than with the two-point contact arrangement.

From the above calculation results, it has been discovered that the smaller the contact angle α₁, the smaller the radial displacement, and that when the contact angle α₁ is 250 or less, the radial rigidity is sufficient. It has also been discovered that the larger the contact angle °₂, the smaller the axial load, and that when the contact angle α₂ is 40° or over, the axial rigidity is sufficient. Based on these calculation results, the contact angle α₁ was limited to the range of 15 to 250, and the contact angle α₂ was limited to the range of 40 to 50°. The lower limit of the contact angle α₁ was set at 15° in order to eliminate the possibility of balls moving onto the counter portion. The upper limit of the contact angle α₂ was set at 500 in order to eliminate the possibility of balls moving onto the shoulder.

The range of the central angle within which the counter portion, which is provided opposite to the shoulder, scarcely bulges, with the balls received by the respective raceways of the inner and outer rings, is about 0 to 78° from the bearing centerline toward the shoulder. In such an angular contact ball bearing, when each ball contacts one of the raceways at two points having different contact angles from each other, wear tends to develop due to the difference in peripheral speed between these two contact points. But such wear does not pose problems because angular ball bearings are rotated at low speeds, and thus the above peripheral speed difference is small.

By determining the spread angle β between the contact angles α₁ and α₂ (β=α₂−α₁) at 20° or over, it is possible to prevent overlapping of the elastic contact deformation regions at the two contact points where each ball contacts the one raceway, thereby sufficiently improving the rigidity due to the two-point contact of the balls.

Here, by bringing each ball into contact with each of the raceways of the inner and outer rings at two points having different contact angles from each other, it is possible to improve the radial rigidity and axial rigidity in a more balanced manner.

In order to achieve the fifth object, the present invention provides an angular contact ball bearing wherein balls are each in contact with respective raceways of an inner ring and an outer ring on opposite sides of a bearing centerline, and wherein the balls are in contact with at least one of the raceways at two contact points having different contact angles from each other, characterized in that the at least one of the raceways comprises two conical surfaces having different cone angles from each other, and that the two contact points are located each on one of the two conical surfaces.

That is, in the arrangement in which the at least one of the raceways comprises two conical surfaces having different cone angles from each other, and the two contact points are located each on one of the two conical surfaces, because the at least one raceway comprise the conical surfaces only, which are curved in the circumferential direction only and thus are easy to machine, it is possible to manufacture a high-rigidity angular contact ball bearing at a low cost.

Here, by bringing each ball into contact with each of the raceways of the inner and outer rings at two points having different contact angles from each other, it is possible to further improve the rigidity of the bearing.

In order to achieve the sixth object, the present invention provides an angular contact ball bearing wherein balls are each in contact with respective raceways of an inner ring and an outer ring on opposite sides of a bearing centerline, and wherein the balls are in contact with at least one of the raceways at two contact points having different contact angles from each other, characterized in that a circumferential oil groove is formed in the at least one of the raceways between the two contact points.

That is, by forming the circumferential oil groove in the at least one of the raceways between the two contact points, it is possible to supply a sufficient amount of lubricating oil into the internal area between the two contact points, where the gap is scarcely present due to elastic contact deformation at each contact point.

By forming the oil groove at a mid-portion between the two contact points, it is possible to provide the oil groove so as not be located in either of the elastic contact deformation areas at the two contact points, thereby preventing edge stress from being produced between balls and the edges of the groove.

By determining the spread angle between the contact angles of the two contact points at 25° or over, too, it is possible to provide the oil groove so as not be located in either of the elastic contact deformation areas at the two contact points, thereby preventing edge stress from being produced between balls and the edges of the groove.

By bringing each ball into contact with each of the raceways of the inner and outer rings at two points having different contact angles from each other, it is possible to further improve the rigidity of the bearing.

### ADVANTAGES OF THE INVENTION

As described above, according to the present invention, because one of the inner and outer rings having the above one raceway is formed with a counter portion on its side axially opposite to its contact points, and with each ball in contact with the one raceway at the two contact points, a gap is present between the portion of the one of the inner and outer rings at the bearing centerline and each of the balls, lubricant can readily reach the two contact points on the one of the raceways of the inner and outer rings, which are offset to the one axial side from the bearing centerline.

Also, in the arrangement of the present invention wherein the balls comprise ceramic balls, it is possible to reduce the weight of the angular contact ball bearing disclosed in the above earlier patent application while keeping the rigidity and wear resistance of its balls.

Also, in the arrangement of the present invention wherein a coating for improving wear resistance is formed on the balls, it is possible to reduce the weight of the angular contact ball bearing disclosed in the above earlier patent application while keeping the wear resistance of its balls.

In the arrangement of the present invention wherein the contact angle α₁ at one of the two contact points that is located closer to the bearing centerline than is the other contact point is 15 to 25°, and the contact angle α₂ at the other contact point is 40 to 50°, it is possible to improve the radial rigidity and the axial rigidity of the angular contact ball bearing in a balanced manner.

In the arrangement of the present invention wherein the at least one of the raceways comprises two conical surfaces having different cone angles from each other, and the two contact points are located each on one of the two conical surfaces, it is possible to reduce the manufacturing cost of a high-rigidity angular contact ball bearing of the type in which each ball is in contact with the raceway at two points.

In the arrangement of the present invention wherein a circumferential oil groove is formed in the raceway between the two contact points at which each ball contacts the raceway, it is possible to supply a sufficient amount of lubricating oil into the internal area between the two contact points between each ball and the raceway.

### BRIEF DESCRIPTION OF THE DRAWINGS

FIG. 1 is a partial sectional view of a first embodiment.

FIG. 2(a) is a partial enlarged sectional view of the outer ring of FIG. 1, and FIG. 2(b) is a partial enlarged sectional view of the inner ring of FIG. 1.

FIG. 3(a) is a partial sectional view showing how the outer ring of FIG. 1 is pulled out, and FIG. 3(b) is a partial sectional view showing the relationship between the retainer and the balls and the center of the bearing shown in FIG. 1.

FIG. 4 is a partial sectional view of a second embodiment.

FIG. 5(a) is a partial enlarged sectional view of the outer ring of FIG. 4, and FIG. 5(b) is a partial enlarged sectional view of the inner ring of FIG. 4.

FIG. 6 is a partial sectional view of a third embodiment.

FIG. 7 is a partial sectional view of a fourth embodiment.

FIG. 8 is a partial sectional view of a fifth embodiment.

FIG. 9 is a sectional side view of a speed reducer in which an angular contact ball bearing according to a sixth embodiment is mounted.

FIG. 10 is a partial sectional view of a seventh embodiment.

FIG. 11(a) is a partial enlarged sectional view of the outer ring of FIG. 10, and FIG. 11(b) is a partial enlarged sectional view of the inner ring of FIG. 10.

FIG. 12 is a partial sectional view of an eighth embodiment.

FIG. 13(a) is a partial enlarged sectional view of the outer ring of FIG. 12, and FIG. 13(b) is a partial enlarged sectional view of the inner ring of FIG. 12.

FIG. 14 is a partial sectional view of a joint assembly for a robotic arm in which the angular contact ball bearing according to the seventh or eighth embodiment is used.

FIG. 15 is a vertical sectional view of a tenth embodiment.

FIG. 16 is a graph illustrating changes in radial rigidity with changes in the contact angle α₁.

FIG. 17 is a graph illustrating changes in axial rigidity with changes in the contact angle α₂.

FIG. 18(a) is a vertical sectional front view of a tester with the tenth embodiment mounted thereon, and FIG. 18(b) is a vertical sectional front view of the tester with a spacer ring mounted thereon.

FIG. 19 is a graph illustrating changes in axial rigidity for an embodiment and a comparative example.

FIG. 20 is a vertical sectional view of an 11th embodiment.

FIG. 21 is a vertical sectional view of a 12th embodiment.

### DESCRIPTION OF REFERENCE NUMERALS

1, 1′, 82, 92, 102. Outer ring
2, 2′, 4, 4′, 81a, 82a, 93, 94, 101a, 102a. Raceway
3, 3′, 81, 91, 101. Inner ring
5, 5′, 84, 96, 104. Retainer
6, 6′, 83, 95, 103. Balls
7, 11, 81c, 82c, 101c, 102c. Counter portion
7′. Large-diameter inner surface
8, 12, 81b, 82b, 91a, 92a, 101b, 102b. Shoulder
8′. Small-diameter inner surface
9, 13. Abutment
11. Small-diameter outer surface
12′. Large-diameter outer surface
93a, 93b, 94a, 94b. Conical surface
93c, 94c. Recess
105. Oil groove
g1, g2. Gap

### BEST MODE FOR EMBODYING THE INVENTION

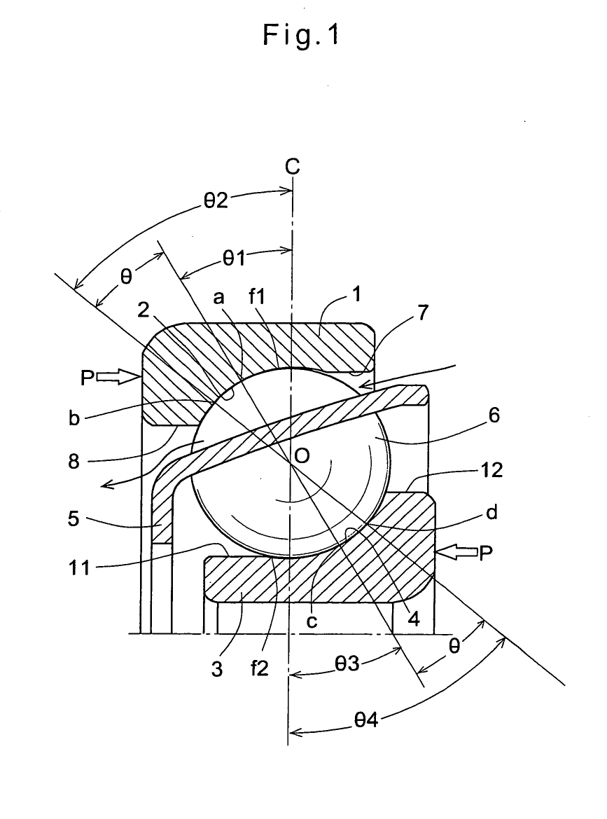

Now description is made of the first embodiment of the present invention, which achieves the abovementioned first object, with reference to the accompanying drawings. As shown in FIG. 1, the angular contact ball bearing according to the first embodiment comprises an outer ring 1 formed with a raceway 2, an inner ring 3 formed with a raceway 4, and balls 6 held between the raceways 2 and 4 so as to be spaced from each other at predetermined intervals by a retainer 5.

The radially inner surface of the outer ring 1 has a large-diameter counter portion 7 at one end thereof, and a small-diameter shoulder 8 at the other end. The raceway 2, which is an arcuate surface as a whole, is formed between the counter portion 7 and the shoulder 8.

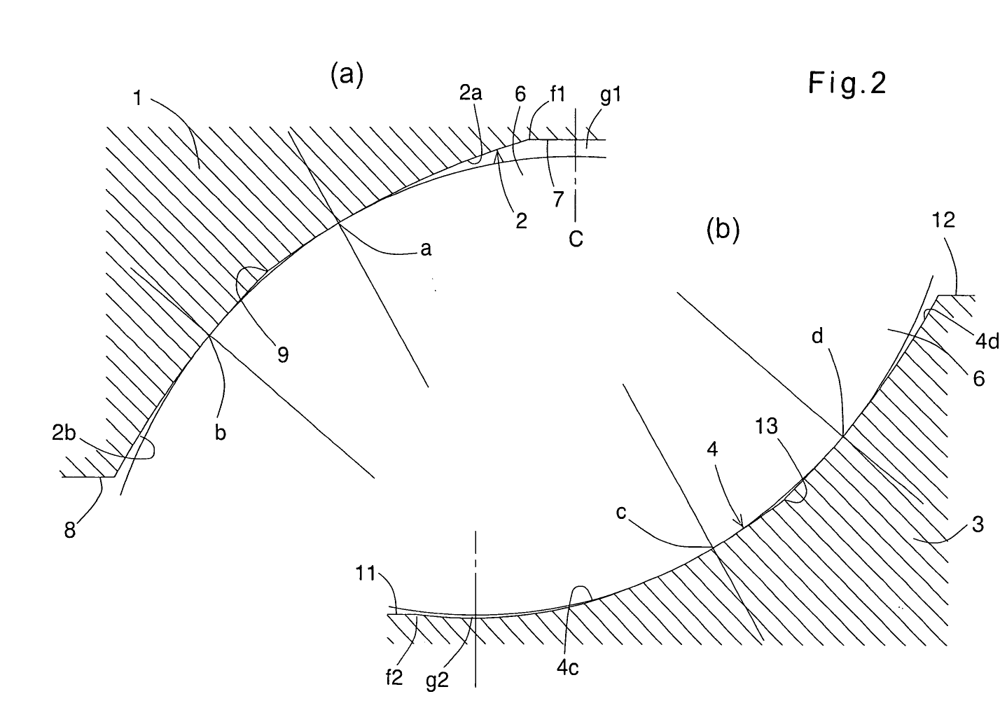

As shown in FIG. 2(a), the raceway 2 comprises two arch-shaped arcuate surfaces 2a and 2b. On both sides of the abutment 9 of the two arcuate surfaces 2a and 2b, contact points a and b with each ball 6 are formed. In FIG. 1, the (contact) angles of the contact points a and b with respect to the centerline C of the bearing are shown by θ1 and θ2, respectively.

The radially outer surface of the inner ring 3 is symmetrical to the radially inner surface of the outer ring 1 with respect to the center point O of the ball 6. In particular, the radially outer surface of the inner ring 3 has a small-diameter counter portion 11 and a large-diameter shoulder 12, with the raceway 4, which is an arcuate surface as a whole, formed between the counter portion 11 and the shoulder 12.

As shown in FIG. 2(b), the raceway 4 comprises two arch-shaped arcuate surfaces 4c and 4d. On both sides of the abutment 13 of the two arcuate surfaces 4c and 4d, contact points c and d with each ball 6 are formed. In FIG. 1, the (contact) angles of the contact points c and d with respect to the centerline C of the bearing are shown by θ3 (=θ1) and θ4 (=θ2), respectively.

As will be apparent from the above description, the two contact points a and b on the raceway 2 of the outer ring 1 are both offset from the centerline C to the side where axial loads P are applied. Similarly, the two contact points c and d on the raceway 4 of the inner ring 3 are also both offset from the centerline C to the side where axial loads P, which are opposite in direction to the axial loads applied to the outer ring, are applied. The minimum value of the angle θ1 (=θ3) is 5°, and the maximum value of the angle θ2 (=θ4) is 80°. The contact angles θ are determined at suitable values within these ranges.

As shown by white arrows in FIG. 1, the axial loads P that can be supported by this bearing are applied to the outer ring 1 only in the direction from the shoulder 8 toward the counter portion 7, and to the inner ring 3 only in the direction from the shoulder 12 toward the counter portion 11. The inner and outer rings cannot support axial loads in the opposite directions thereto.

Because each axial load P which is directed in one direction only is supported at two points, the load is dispersed, so that the load applied to one point is small compared to the arrangement in which the entire load is supported at one point. This reduces deformation of the bearing, thus increasing its rigidity.

The outer ring 1 and the inner ring 3 are formed with the counter portions 7 and 11 on the axial sides opposite to the sides where there are the contact points a and b, and c and d, respectively. The outer ring 1 is of the separate type, while the inner ring 3, the retainer 5 and the balls 6 form an assembly.

More specifically, as shown in FIGS. 1, 2(a) and 3(a), with each ball 6 in contact with the raceway 2 at two points, the inner diameter Ri of the counter portion 7 is larger than the diameter of the circumscribed circle of the balls 6, and the boundary f1 between the raceway 2 and the counter portion 7 is offset from the centerline C of the bearing toward the shoulder 8.

As shown in FIGS. 1, 2(b) and 3(a), the boundary f2 between the raceway 4 and the counter portion 11 is offset from the centerline C of the bearing away from the shoulder 12, and the outer diameter Re of the counter portion 11 is larger than the diameter of the smallest inscribed circle of the balls 6 when the balls are retained by the retainer 5 only. The interference between the outer diameter Re of the counter portion 11 and the diameter of the circle A (Re-A) prevents separation of the retainer 5 and the balls 6 after the bearing has been assembled. At the centerline C of the bearing, the raceway 4 has a diameter that is smaller than the inscribed circle of the balls 6 with each ball in contact with the raceway 4 at two points.

With this arrangement, as shown in FIGS. 2(a) and 2(b), with each ball 6 in contact with the raceway 2 at two points, a gap g1 is present between the portion of the outer ring 1 at the bearing centerline C and the respective balls 6. Also, with each ball 6 in contact with the raceway 4 at two points, a gap g2 is present between the portion of the inner ring 3 at the bearing centerline C and the respective balls 6.

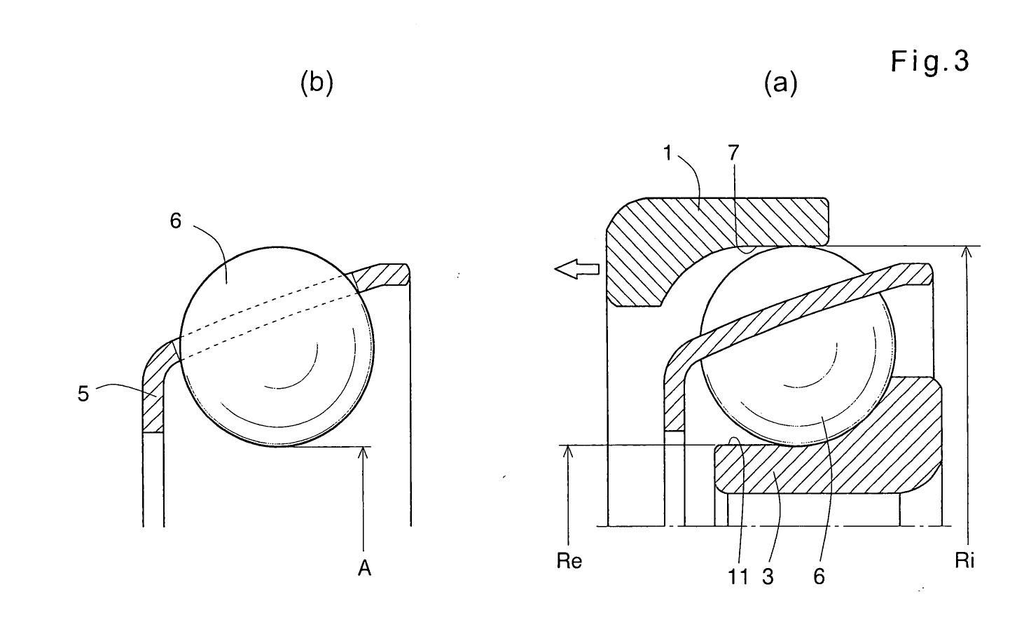

As shown in FIG. 3(a), the counter portion 7 makes it possible for the outer ring 1 to move in the direction opposite to the direction in which the axial load is applied to the outer ring. Thus, the outer ring 1 is freely separable from the inner ring assembly comprising the inner ring 3, retainer 5 and balls 6.

This angular contact ball bearing is used e.g. under lubrication of circulated oil. As shown by arrows in FIG. 1, according to the direction of the curve of the retainer 5, lubricating oil is supplied from outside the bearing and flows smoothly through the space between the counter portion 7 and the retainer 5 to the bearing centerline C, and then flows around the balls 6 as the balls roll and is supplied through the gap g1 to the contact point a.

As with this angular contact ball bearing, in an arrangement in which each ball is brought into contact with the raceway of each of the inner and outer rings at two points, a counter portion is preferably formed on each of the inner and outer rings. But according to use conditions, a counter portion may be formed only on one of the inner and outer rings. In this arrangement too, lubricating oil supplied from the single counter portion and flows smoothly around the balls as the balls roll to the contact points on the other sides. Thus, the contact points on the other side can be lubricated sufficiently.

The counter portion 7 may be configured such that the boundary f1 is located on the bearing centerline C, and its inner diameter at the boundary f1 is larger than the diameter of the circumscribed circle of the balls.

Also, the angular contact ball bearing may comprise an assembly of the outer ring 1, retainer 5 and balls 6, and a separate inner ring 3. Because one of the inner and outer rings is of the separate type, the bearing can be easily assembled even in a small space.

The balls 6 may be made of steel or a ceramic material.

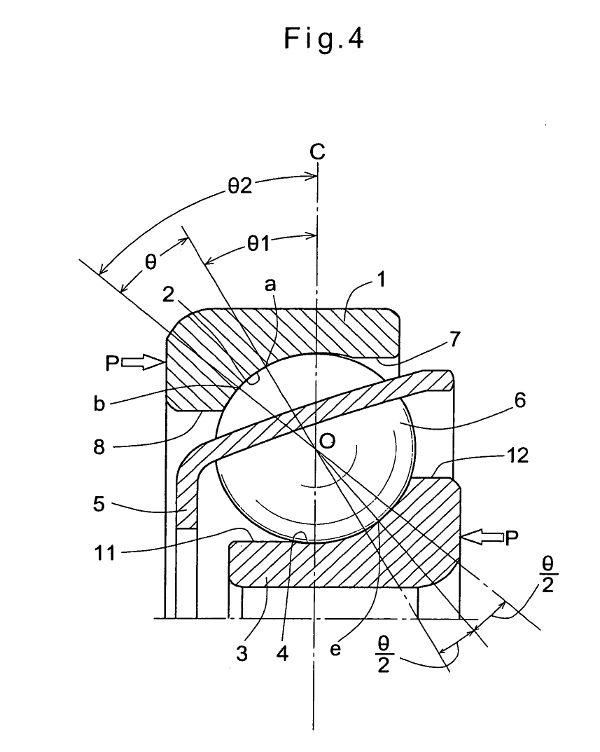

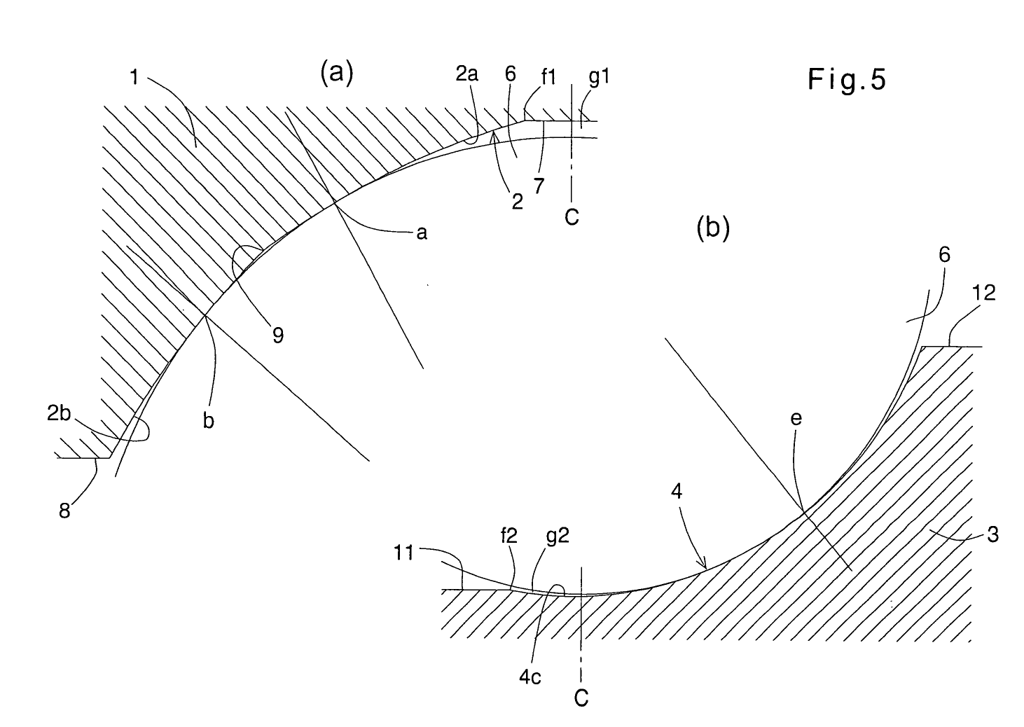

The second embodiment for achieving the first object is now described. Description of elements identical or similar to those of the first embodiment is omitted. The angular contact ball bearing according to the second embodiment, shown in FIGS. 4 and 5, is basically of the same structure as the first embodiment, but differs therefrom in that the raceway 4 of the inner ring 3 is an arcuate surface as a whole, and each ball 6 is in contact with the raceway 4 at only one point e. The contact point e is located on the bisector of the difference between the contact angles θ1 and θ2 (θ/2). Because each ball 6 contacts the outer ring 1 at two points, this bearing is a three-point contact angular ball bearing. With this arrangement, although the rigidity of the inner ring 3 is not very high, the rigidity of the outer ring 1 is as high as the outer ring of the first embodiment.

Conversely to the arrangement of this angular contact ball bearing, each ball may be brought into contact with the raceway 2 of the outer ring 1 at one point, and with the raceway 4 of the inner ring 3 at two points.

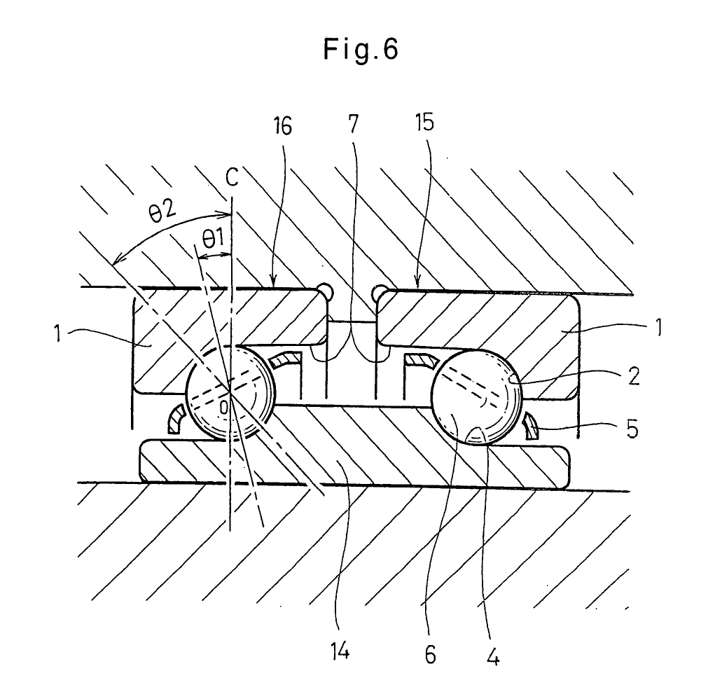

The third embodiment for achieving the first object is now described. The angular contact ball bearing according to the third embodiment, shown in FIG. 6, is of the face-to-face duplex structure comprising an integral double-row inner ring 14, and separate outer rings 1.

This bearing comprises first and second arrays 15 and 16 each comprising a raceway 2, a raceway 4, an outer ring 1, a retainer 5, and a set of balls 6, and having equal nominal contact angles. Since the raceways 2 and 4 are symmetrical with respect the lines connecting the abutments 9 and 13 and the center O of each ball, respectively, the nominal contact angles are calculated according to the equation: (θ1−θ2)/2.

Each ball 6 of either of the first and second arrays 15 and 16 is in contact with each of the raceways 2 and 4 at two points, with the values of θ1 and θ3 set at 15° and the values of θ2 and θ4 set at 45°. Thus, the nominal contact angles in the first and second arrays 15 and 16 are both 30°. This determines the nominal lines of action. Because the angular contact ball bearing according to the third embodiment is of the face-to-face duplex structure, the nominal lines of action of the first and second arrays 15 and 16 intersect each other inside the bearing.

Lubricating oil supplied into the space between the outer rings 1 flows along the counter portion 7 into the first and second arrays 15 and 16. This is because the retainers 5 are arcuately curved. According to the structures of the retainers and the housing and the use environment, oil circulation paths and the lubricating method can be determined.

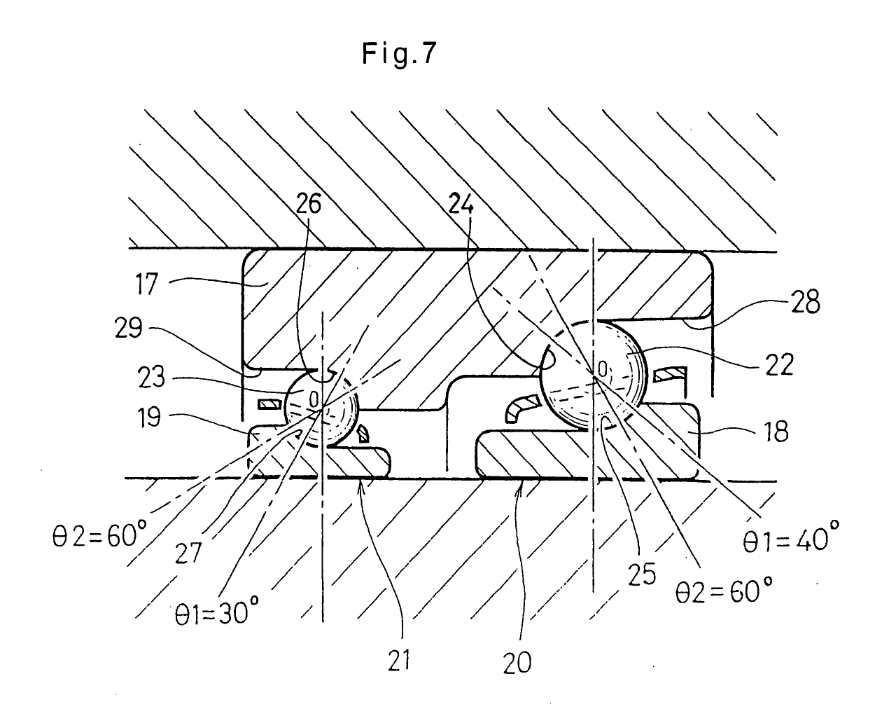

The fourth embodiment for achieving the first object is now described. The angular contact ball bearing according to the fourth embodiment, shown in FIG. 7, is of the back-to-back duplex structure comprising an integral double-row outer ring 17, and separate inner rings 18 and 19.

This bearing has first and second arrays 20 and 21 that are different in ball specifications, bearing sizes, contact states and nominal angle from each other. With this arrangement, if there is a large difference in applied load between the two opposite axial directions, it is possible to equalize the loads applied to the first and second arrays 20 and 21, thus making it possible to adjust the bearing rigidity and lifespan.

The ball specifications include the ball diameter and their number. The bearing sizes include the bearing inner and outer diameters and width, the outer diameters of the counter portions, and the radii of curvature of the radially inner raceways. The contact states include the numbers of contact points on one and the other raceways, and the total number of the contact points on both raceways.

Specifically, the diameter and the number of the balls 22 in the first array 20 are larger than those of the balls 23 in the second array 21. Corresponding to these differences in the ball specifications, the respective sizes of the outer ring 17 and the inner rings 18 and 19 are different.

As for the contact states in the first array 20, each ball is in contact with the raceways 24 and 25 at two points each, a total of four points. As for the contact states in the second array 21, each ball is in contact with the raceway 26 of the outer ring 17 at one point, and with the raceway 27 of the inner ring 19 at two points, a total of three points. This is because the portion of the outer ring in the second array 21 has a larger wall thickness, so that its deformation is sufficiently small.

In the first array 20, the values θ1 and θ3 are set at 40° while the values θ2 and θ4 are set at 60°, and the nominal contact angle is set at 50°. In the second array 21, the value θ1 is set at 30° while the value θ2 is set at 60°, and the nominal contact angle is 45°.

Lubricating oil flows along the counter portion 28 of the first array 20, flows through the second array 21, and flows out from the counter portion 29.

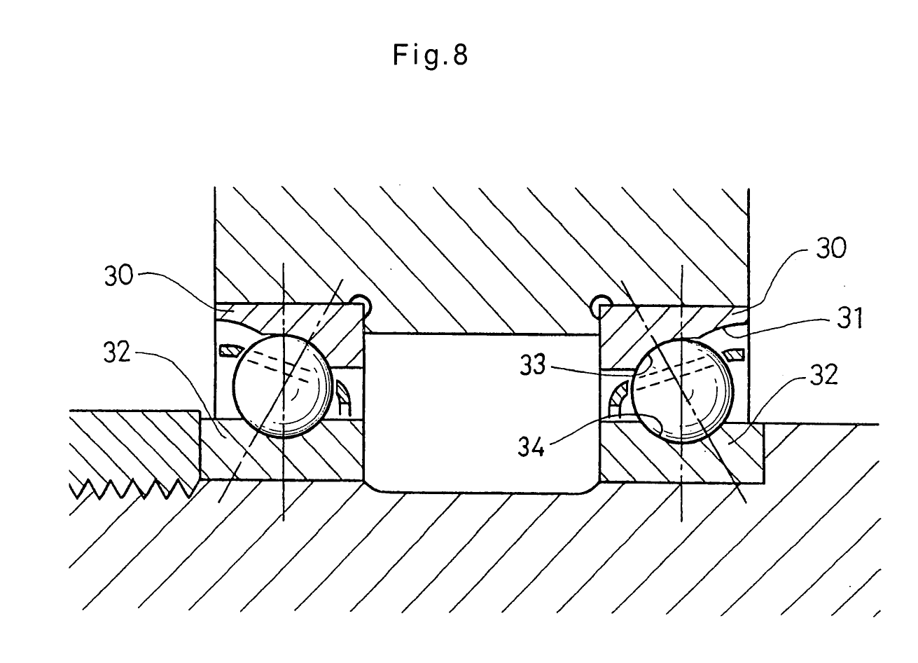

The fifth embodiment for achieving the first object is now described. The angular contact ball bearing according to the fifth embodiment, shown in FIG. 8, is of the back-to-back duplex structure including separate outer rings 30.

Each outer ring 30 has a tapered counter portion 31 so that lubricating oil flows smoothly into the bearing. Each inner ring 32 has shoulders on both sides. Each ball contacts the raceway 33 of the outer ring 30 and the raceway 34 of the inner ring 32 at two points each, a total of four points.

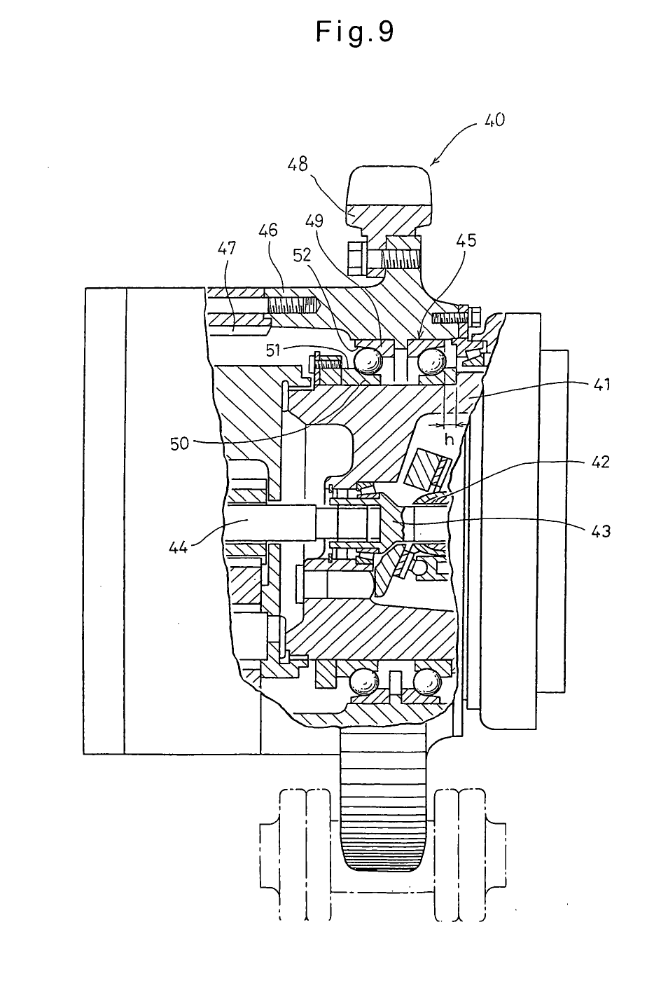

A speed reducer is now described in which is mounted an angular contact ball bearing according to the sixth embodiment for achieving the first object. This speed reducer, shown in FIG. 9, is a driving unit 40 for driving caterpillars or wheels of a construction vehicle. The driving unit 40 includes a case 41 in which a hydraulic motor 42 is mounted. To the output shaft 43 of the hydraulic motor 42, a first sun gear 44 of a first planetary speed reducing mechanism is coupled. To the case 41, a drum 46 is rotatably mounted through a main bearing 45. To the drum 46, a ring gear 47 is fixedly mounted. A sprocket 48 is mounted on the outer periphery of the drum 46. While not shown, the ring gear 47 meshes with first planetary gears of the first planetary speed reducing mechanism. Also, a first carrier supporting the first planetary gears meshes with a second sun gear of a second planetary speed reducing mechanism. The second sun gear in turn meshes with second planetary gears which are rotatably supported by pins fixed to the case 41. The second planetary gears mesh with the ring gear 47.

With this driving unit 40, when the first sun gear 44 is rotated by the hydraulic motor 42, its power is transmitted through the first planetary speed reducing mechanism to the second planetary speed reducing mechanism, so that the power is transmitted to the ring gear 47 after its speed has been reduced in two stages. The sprocket 48 is thus driven at a reduced speed.

The main bearing 45 is the angular contact ball bearing according to the sixth embodiment, which is of the back-to-back duplex structure. The main bearing 45 includes outer rings 49 fitted in the drum 46, and inner rings 50 fitted on the case 41. That is, the main bearing 45 is disposed between the output shaft of the speed reducer (which comprises the ring gear 47 and the drum 46) and the driving side. A preload is applied to the main bearing 45.

The inner and outer rings of the main bearing 45 are offset from each other by a distance h such that the shoulder 51 of each inner ring 50 is located axially outside the counter portion 52 of the corresponding outer ring 49. This arrangement increases the spaces between the shoulders 51 and the counter portions 52, so that lubricating oil can more smoothly flow into the bearing.

Because the main bearing 45 has improved rigidity compared to conventional such bearings as mentioned above, it is possible to correspondingly reduce the wall thickness of the drum 46. By reducing the wall thickness of the drum 46, it becomes possible to weld the drum 46 to the ring gear 47 and thus to reduce the manufacturing cost of the driving unit 40.

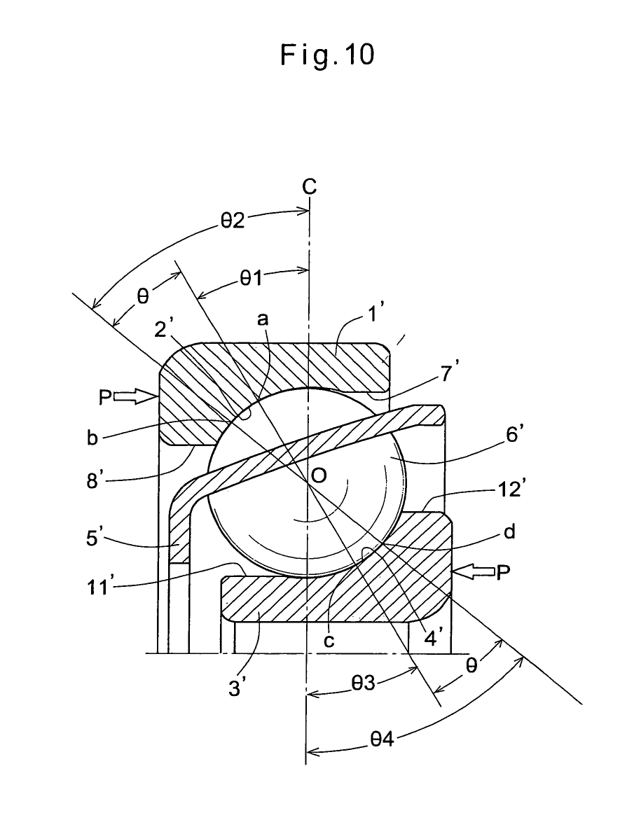

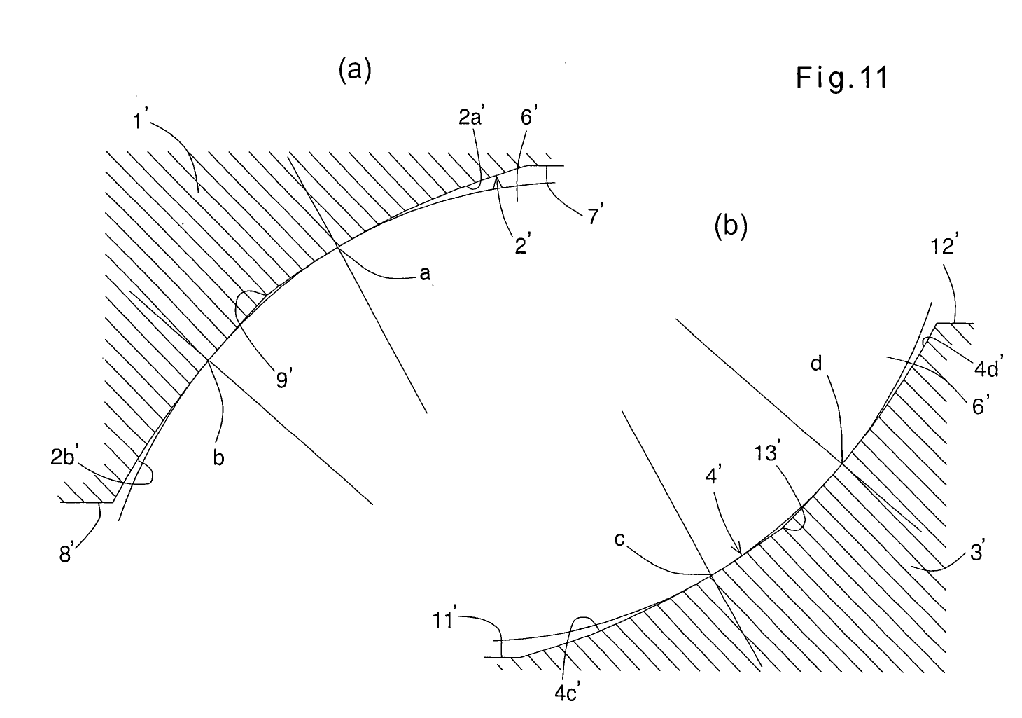

Now referring to FIGS. 10 and 11, description is made of the seventh embodiment for achieving the second objection.

As shown in FIG. 10, this bearing is an angular contact ball bearing comprising an outer ring 1′ having a raceway 2′, an inner ring 3′ having a raceway 4′, balls 6′ disposed between the raceways 2′ and 4′, and a retainer 5′ spacing the balls 6′ from each other at predetermined intervals.

On the radially inner surface of the outer ring 1′, a large-diameter inner surface 7′ and a small-diameter inner surface 8′ are formed at both ends thereof. The raceway 2′, which is arcuate as a whole, is formed between the inner surfaces 7′ and 8′. As is apparent from FIG. 11(a), the raceway 2′ comprises two arch-shaped arcuate surfaces 2a′ and 2b′. Contact points a and b with each ball 6′ are formed on both sides of the abutment 9′ between the arcuate surfaces 2a′ and 2b′. In FIG. 10, the contact angle at the contact point a with respect to the bearing centerline C is indicated by θ1, while the contact angle at the contact point b with respect to the bearing centerline C is indicated by θ2.

The radially outer surface of the inner ring 3′ is symmetrical to the radially inner surface of the outer ring 1′ with respect the center point O of the ball 6′. In particular, the radially outer surface of the inner ring 3′ has a small-diameter outer surface 11′ and a large-diameter outer surface 12′ at both ends thereof. The raceway 4′, which is arcuate as a whole, is formed between the outer surfaces 11′ and 12′. As is apparent from FIG. 11(b), the raceway 4′ comprises two arch-shaped arcuate surfaces 4c′ and 4d′. Contact points c and d with each ball 6′ are formed on both sides of the abutment 13′ between the arcuate surfaces 4c′ and 4d′. In FIG. 10, the contact angle at the contact point c with respect to the bearing centerline C is indicated by θ3 (=θ1), while the contact angle at the contact point d with respect to the bearing centerline C is indicated by θ4 (=θ2).

As will be apparent from the above description, according to the present invention, the two contact points a and b on the raceway 2′ of the outer ring 1′ are both offset from the bearing centerline C to the side where axial loads P are applied. Similarly, the two contact points c and d on the raceway 4′ of the inner ring 3′ are also both offset from the bearing centerline C to the side where axial loads P, which are opposite in direction to the axial loads applied to the outer ring, are applied. The minimum values of the angle θ1 (=θ3) is 5°, and the maximum value of the angle θ2 (=θ4) is 80°. The contact angles θ are determined at suitable values within these ranges.

As shown by white arrows in FIG. 10, the axial loads P that can be supported by this bearing are applied to the outer ring 1′ only in the direction from the small-diameter inner surface 8′ toward the large-diameter inner surface 7′, and to the inner ring 3′ only in the direction from the large-diameter outer surface 12′ toward the small-diameter outer surface 11′. The inner and outer rings cannot support axial loads in the opposite directions thereto.

Because each axial load P which is directed in one direction only is supported at two points, the load is dispersed, so that the load applied to one point is small compared to the arrangement in which the entire load is supported at one point. This reduces deformation of the bearing, thus increasing its rigidity.

The balls 6′ of this embodiment are ceramic balls of silicon nitride. The silicon nitride ceramic balls have e.g. a density of about 3.20 to 3.29 [Mg/m³] (JIS R 4108), a Vickers hardness of about 1400 to 1500 (JIS R 1610: Hv500), a bending strength of about 900 to 1100 [MPa] (JIS R 1601: three-point bending), and a fracture toughness of about 5.5 to 7.0 [MPa·m(½)] (JIS R 1607: NIIHARA's method). The outer and inner rings 1′ and 3′ may be made of e.g. bearing steel.

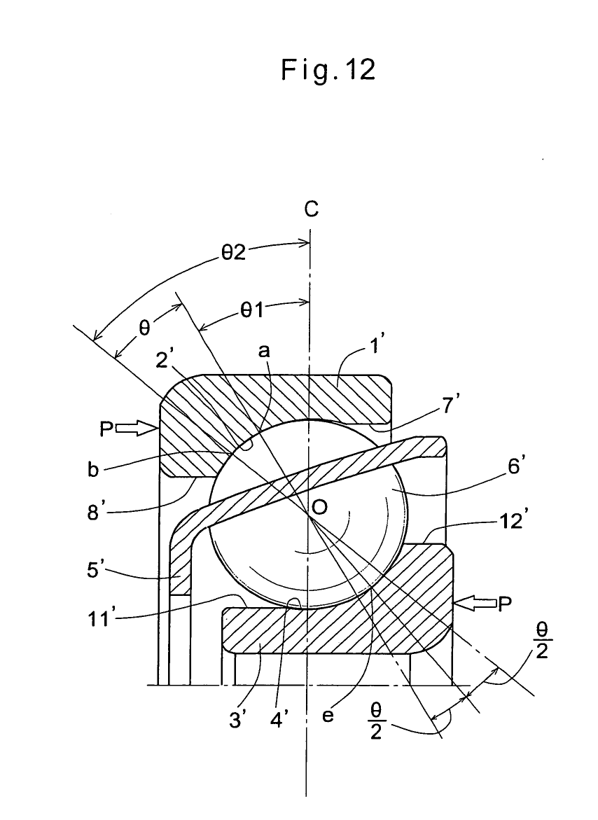

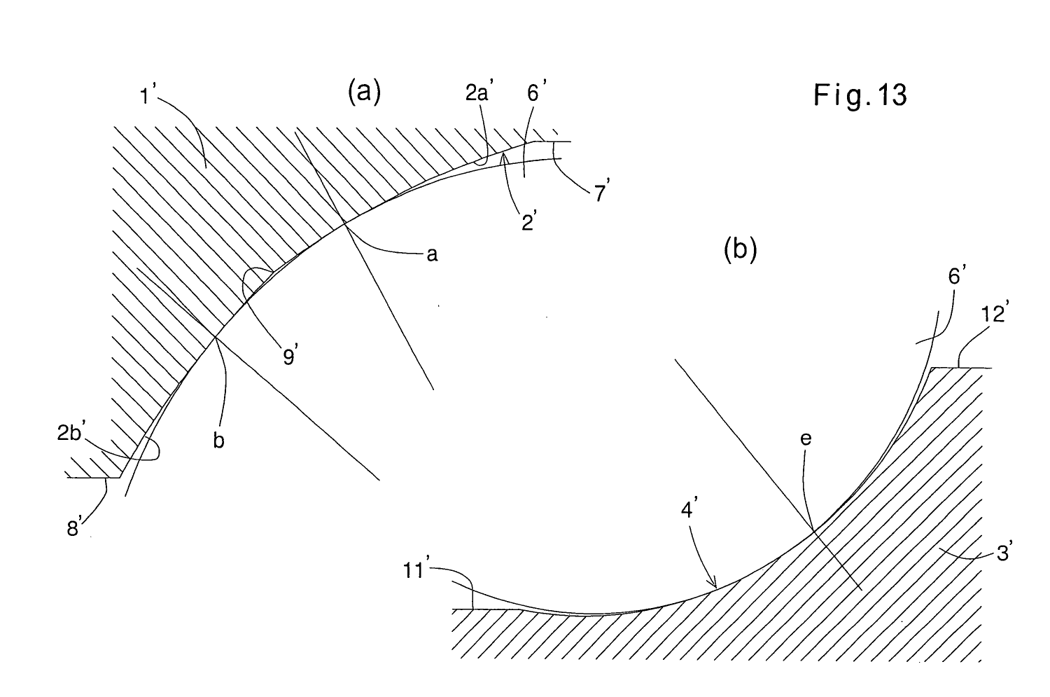

Now the eighth embodiment for achieving the second object is described. The angular contact ball bearing according to the eighth embodiment, shown in FIGS. 12 and 13, is basically of the same structure as the seventh embodiment, but differs therefrom in that the raceway 4′ of the inner ring 3′ is an arcuate surface as a whole, and each ball 6′ is in contact with the raceway 4′ at only one point e. The contact point e is located on the bisector of the difference between the contact angles θ1 and θ2 (θ/2). Because each ball contacts the outer ring 1′ at two points, this bearing is a three-point contact angular ball bearing. With this arrangement, although the rigidity of the inner ring 3′ is not very high, the rigidity of the outer ring 1′ is as high as the outer ring of the first embodiment.

Conversely to this arrangement, each ball may be brought into contact with the raceway 2′ of the outer ring 1′ at one point, and with the raceway 4′ of the inner ring 3′ at two points.

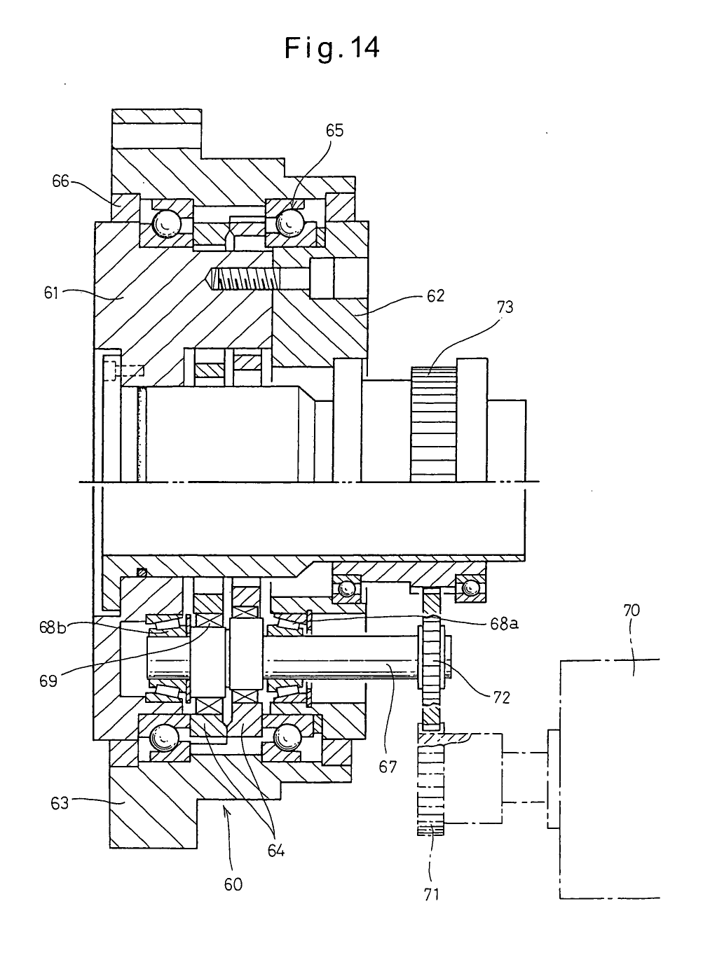

Now a joint assembly for a robotic arm is described in which the angular contact ball bearing according to the seventh embodiment is mounted. The joint assembly for a robotic arm, shown in FIG. 14, includes a speed reducer 60 in the form of an eccentric differential speed reducer. The speed reducer 60 is configured to drive a pivot member 62 having an output shaft 61 fixed to the arm.

Specifically, the speed reducer 60 includes a case 63 fixed between the pivot member 62 and the base seat, the output shaft 61, which is in the form of a carrier mounted in the case 63 and fixed to the pivot member 62, and a pinion 64 with external teeth that mesh with pin teeth provided on the inner periphery of the case 63. Main bearings 65 are mounted between the output shaft 61 and the case 63.

The main bearings 65 comprise two of the angular contact ball bearings according to the seventh embodiment in the form of back-to-back duplex bearings. The main bearings 65 are disposed between the outer periphery of the output shaft 61 and the inner periphery of the case 63 to support the output shaft 61 so as to be rotatable relative to the case 63. Between flanges on both sides of the output shaft 61 and the respective ends of the case 63, seal members 66 are disposed. The main bearings 65 are lubricated with grease.

A plurality of crank pins 67 are each inserted in one of through holes formed in the pinion 64. The crank pins 67 are rotatably supported by the output shaft 61 through bearings 68a and 68b. Each crank pin 67 has two eccentric crank portions at its central portion. The crank portions are inserted in the pinion 64 through needle bearings 69.

A driving motor 70 is mounted on the pivot member 62. An external gear 71 fixed to the output shaft of the motor 70 directly meshes with an external gear 72 fixed to one of the crank pins 67. Thus, rotation torque of the external gear 71 is transmitted to the external gear 72, thereby rotating the crank pin 67.

The external gear 72 also directly meshes with a gear 73 rotatably supported by the pivot member 62 through a bearing. The gear 73 also meshes with the crank pins other than the crank pin 67 directly connected to the motor. Thus, the rotation torque transmitted from the external gear 72 to the gear 73 is distributed to the other crank pins.

With this arrangement, when the crank pins 67 are rotated once, the center of the pinion rotates once about the axis of the speed reducer. In this arrangement, because the number of the external teeth of the pinion 64 is smaller than the number of the pin teeth of the case, and because the case 63 is fixed to the base seat, the rotation transmitted to the crank pins 67 is reduced in a high ratio and transmitted to the output shaft 61 and the pivot member 62.

The ninth embodiment according to the present invention for achieving the third object is now described. The angular contact ball bearing according to the ninth embodiment differs from the seventh and eighth embodiments only in the structure of the balls. Thus, FIGS. 10 to 14 represent the ninth embodiment, too.

To the balls of the angular contact ball bearing according to the ninth embodiment, a coating for improving wear resistance is applied. The coating is applied by e.g. chrome electroplating, electroless nickel plating, molybdenum disulfide coating or Raydent treatment.

The ball bodies to which the above coating is applied may be made of steel or a ceramic material.

The main bearings 65 used in the joint assembly for a robotic arm shown in FIG. 14 may be the angular contact ball bearings according to the ninth embodiment.

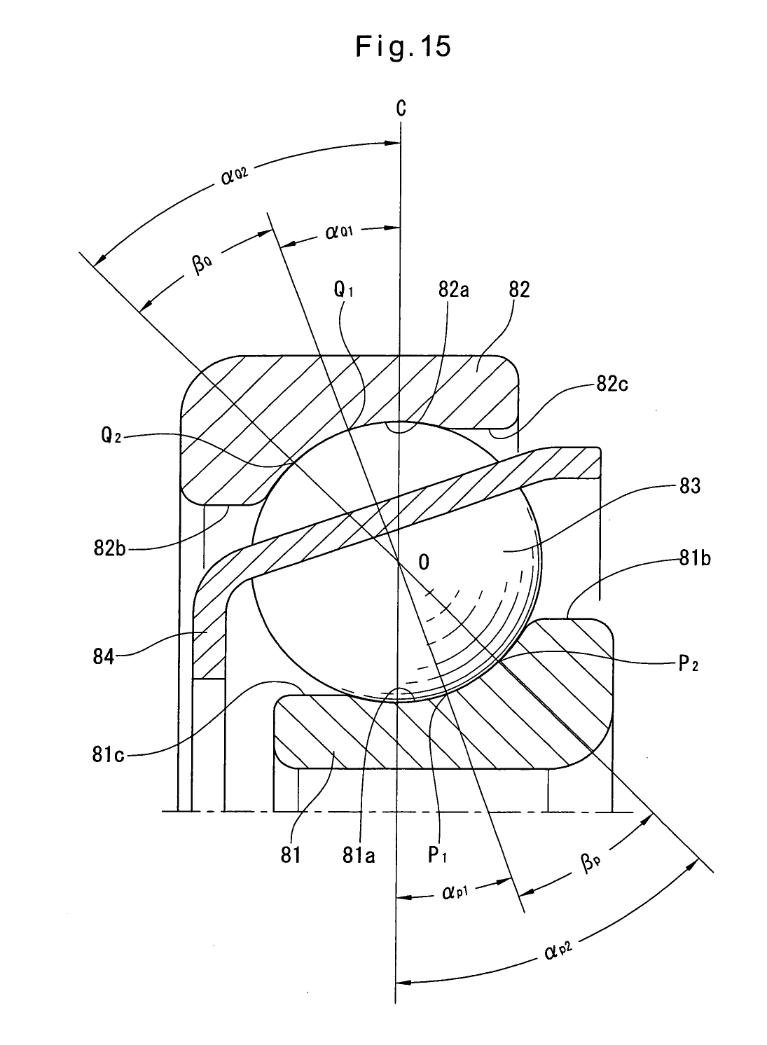

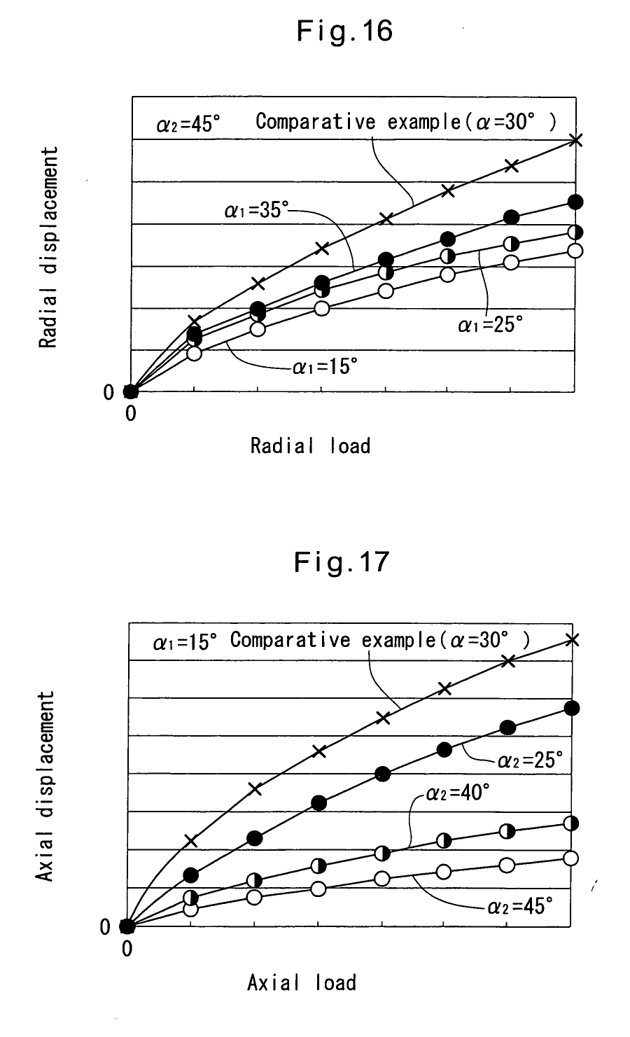

The tenth embodiment according to the present invention for achieving the fourth object is now described. As shown in FIG. 15, the angular contact ball bearing according to the tenth embodiment includes an inner ring 81 having a raceway 81a, an outer ring 82 having a raceway 82a, and a plurality of balls 83 retained by a retainer 84 between the raceways 81a and 82a. The inner ring 81 and the outer ring 82 have shoulders 81b and 82b provided on opposite sides of the bearing centerline C that passes the center O of the bearing. On the other side of the respective raceways 81a and 82a from the shoulders 81b and 82b, counter portions 81c and 82c are formed.

Each ball 83 is in contact with the raceway 81a of the inner ring 81 at two points P₁ and P₂ that are offset from the bearing centerline C toward the shoulder 81b, and with the raceway 82a of the outer ring 82 at two points Q₁ and Q₂ that are similarly offset from the bearing centerline C toward the shoulder 82b. The contact angles α_{P1} and α_{Q1} at contact points P₁ and Q₁ of each ball 83 with the respective raceways 81a and 82a, which is closer to the bearing centerline C than are the other contact points are both 15 to 25°. The contact angles α_{P2} and α_{Q2} at the contact points P₂ and Q₂, which are remote from the bearing centerline C, are both 40 to 50°. The spread angle β_{P} between the contact angles α_{P1} and α_{P2}, as well as the spread angle β_{Q} between the contact angles α_{Q1} and α_{Q2}, is 20° or over. With the angular contact ball bearing according to the tenth embodiment, the contact angles α_{P1} and α_{P2} on the inner ring 81 are symmetrical to and thus equal to the contact angles α_{Q1} and α_{Q2} on the outer ring 82, respectively, with respect to the bearing center O.

With the angular contact ball bearing according to the tenth embodiment, each ball is in contact with either of the raceways of the inner and outer rings at two points, and the contact angles at the respective contacts points of both raceways are symmetrical to and equal to each other with respect to a point. But they do not necessarily have to be symmetrical to and equal to each other with respect to a point. Also, each ball may be brought into contact with only one of the raceways at two points.

An axial rigidity measurement test was conducted on the angular contact ball bearing according the tenth embodiment (hereinafter simply referred to as the “embodiment”) and an angular contact ball bearing according to a comparative example (hereinafter simply referred to as the “comparative example”). The test results are shown below. The below description clarifies the properness of calculations based on the above elastic contact theory.

Both the embodiment and the comparative example have a bearing inner diameter d of 240 [mm], a bearing outer diameter D of 310 [mm], and a bearing height T of 33 [mm].

In the embodiment, each ball contacts the raceways at four points, and the contact angles α_{P1} and α_{Q1} are 20°, while the contact angles α_{P2} and α_{Q2} are 40°.

The comparative example differs from the embodiment only in that each ball contacts each of the raceways of the inner and outer rings at one point on the other side of the bearing centerline from the other contact point, and that the contact angle α at each raceway is 30°.

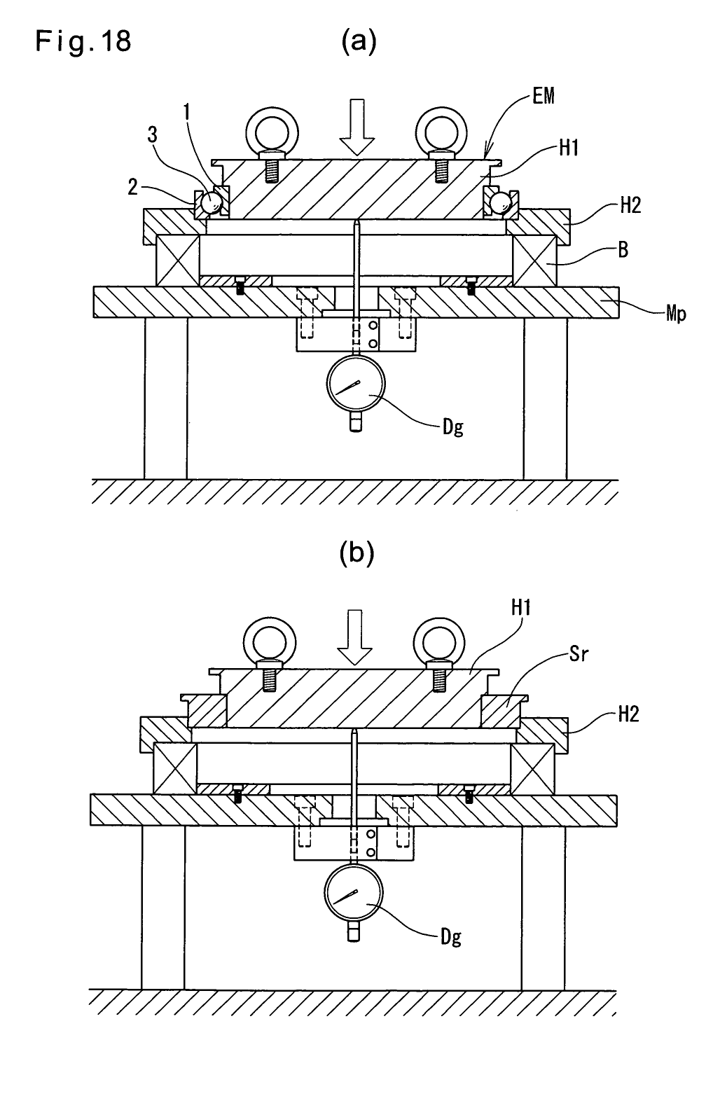

The axial rigidities of the embodiment and the comparative example were measured using a tester EM shown in FIG. 18(a). The tester EM comprises a measuring table Mp fixed on the ground, a loading housing H1 onto which the inner ring 1 of the embodiment is fitted, a receiving housing H2 into which the outer ring 2 of the embodiment is fitted, a thrust bearing B supporting the receiving housing H2 on a horizontal plate of the measuring table Mp, and a dial gauge Dg having a measuring probe that extends perpendicular to the horizontal plate of the measuring table Mp.

With the embodiment mounted on the tester EM, the central axis of the bearing extends in the vertical direction. In this state, the end surface of the shoulder of the inner ring 1 is prevented from moving vertically upwardly by a shoulder formed on the outer periphery of the loading housing H1, while the end surface of the shoulder of the outer ring 2 is prevented from moving vertically downwardly by a shoulder formed on the inner periphery of the receiving housing H2.

As shown by the white arrow in FIG. 18(a), a vertically downward load is applied to the top surface of the housing H1, so that a pure axial load is applied to the embodiment. Even under this pure axial load, because the end surfaces of the shoulders of the inner and outer rings 1 and 2 are prevented from moving by the housings H1 and H2, the embodiment never separates from the housings H1 and H2.

The housings H1 and H2 have symmetrical axes that are aligned with the bearing central axis of the embodiment, and have a circular or annular section along any plane that is perpendicular to the respective symmetric axes. Thus, they are circumferentially uniform in rigidity balance.

With this tester EM, because the receiving housing H2 is supported by the thrust bearing B so as to be rotatable about the bearing central axis, measurement can be made even with the balls 3 of the embodiment rolling.

The measuring probe of the dial gauge Dg contacts the center of the bottom surface of the loading housing (i.e. the symmetric axis of the loading housing H1, which is the centerline of the rigidity balance of the housing H1), because with this arrangement, it is possible to most accurately measure the vertically downward movement of the loading housing H1.

Needless to say, the comparative example, which differs from the embodiment only in the manner in which the balls contact the raceways, can also be mounted in the tester EM in the same manner as the embodiment.

Now description is made of how the axial rigidity is measured in the axial rigidity measurement test using the tester EM.

(I) The rigidity of the tester is measured. That is, as shown in FIG. 18(b), a spacer ring Sr is mounted between the loading housing H1 and the receiving housing H2. The spacer ring Sr has an inner diameter d=240 [mm], an outer diameter D=310 [mm], and a height T=33 [mm], and thus is of a size corresponding to the embodiment.

With the spacer ring Sr mounted, a pure axial load is applied. The pure axial load was changed from 9807 [N] to 98067 [N].

With the pure axial load of 9807 [N] applied, the value of the dial gauge was adjusted to zero. The gauge value was set to zero with a slight load applied because with zero load, the gauge value tends to fluctuate.

In order to measure the rigidity of the tester, as the spacer ring Sr, one having such rigidity that it moves only a negligibly small distance in the axial direction under the maximum pure axial load.

(II) Then, the rigidity of the tester is measured with a test bearing mounted. With a test bearing (the embodiment or the comparative example) mounted between the loading housing H1 and the receiving housing H2, measurement was made in the same manner as the spacer ring Sr is mounted.

(III) Next, the rigidity of the test bearing is measured. That is, the rigidity of the bearing is calculated by subtracting the measured value obtained in (I) from the measured value obtained in (II) under the same pure axial load. By performing this subtraction, it is possible to eliminate the influence of the axial displacement of the tester itself and thus to obtain the axial displacement of the test bearing.

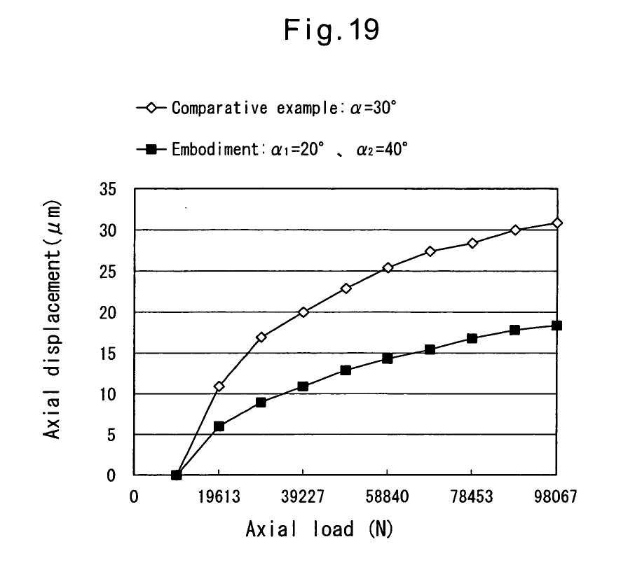

Measurement results (I) to (III) for the embodiment and the comparative example are shown in line graphs in FIG. 19.

Comparison of FIG. 17 with FIG. 19 indicates that between the line graphs by the calculation based on the elastic contact theory (FIG. 17) and the above measurement results, the changing tendencies of the axial displacement (i.e. axial rigidity) according to the change in the pure axial load are similar to each other. Thus, it was possible to confirm the properness of the calculation based on the elastic contact theory.

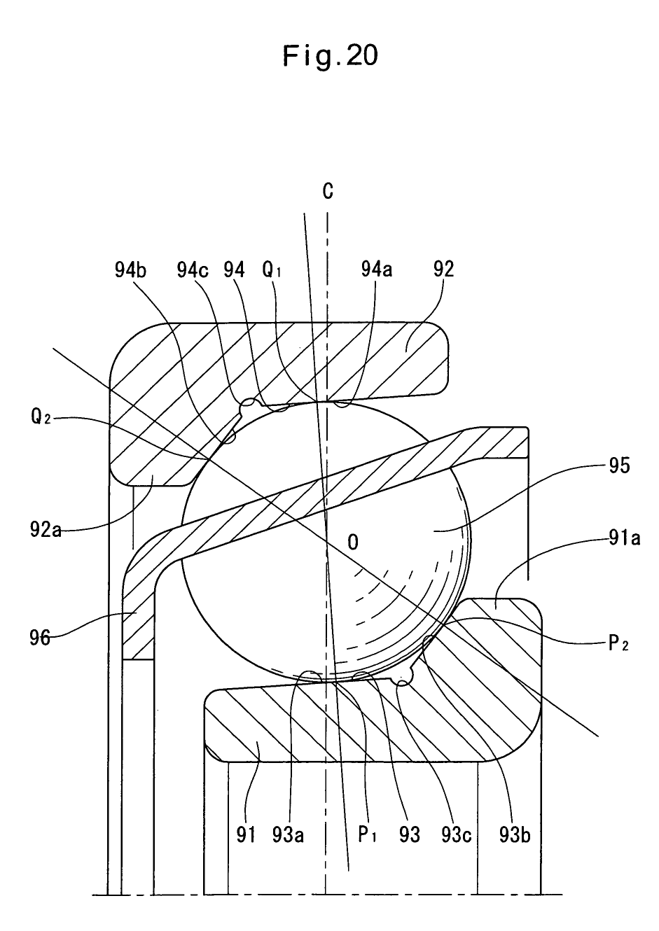

Description is now made of the 11th embodiment of the present invention for achieving the fifth object. As shown in FIG. 20, the angular contact ball bearing according to the 11th embodiment comprises an inner ring 91 having a raceway 93, an outer ring 92 having a raceway 94, and a plurality of balls 95 held between the raceways 93 and 94 by a retainer 96. The inner ring 91 and the outer ring 92 have shoulders 91a and 92a, respectively, which are provided on opposite sides of the bearing centerline C that passes the center O of the bearing.

Each of the raceway 93 of the inner ring 91 and the raceway 94 of the outer ring 92 comprises two conical surfaces 93a and 93b, or 94a and 94b, which have different cone angles from each other. Each ball 95 contacts the conical surfaces 93a and 93b of the raceway 93 of the inner ring 91 at points P₁ and P₂, respectively, that are offset toward the shoulder 91a from the bearing centerline C. Similarly, each ball 95 contacts the conical surfaces 94a and 94b of the raceway 94 of the outer ring 92 at points Q₁ and Q₂, respectively, that are offset toward the shoulder 92a from the bearing centerline C. Recesses 93c and 94c for machining are formed along the boundaries between the conical surfaces 93a and 93b and between the conical surfaces 94a and 94b, respectively.

With the angular contact ball bearing according to the 11th embodiment, each of the raceways of the inner and outer rings comprises two conical surfaces with each ball in contact with each raceway at two points. But the raceway of only one of the inner and outer rings may be formed of two conical surfaces so that each ball contacts only this raceway at two points.

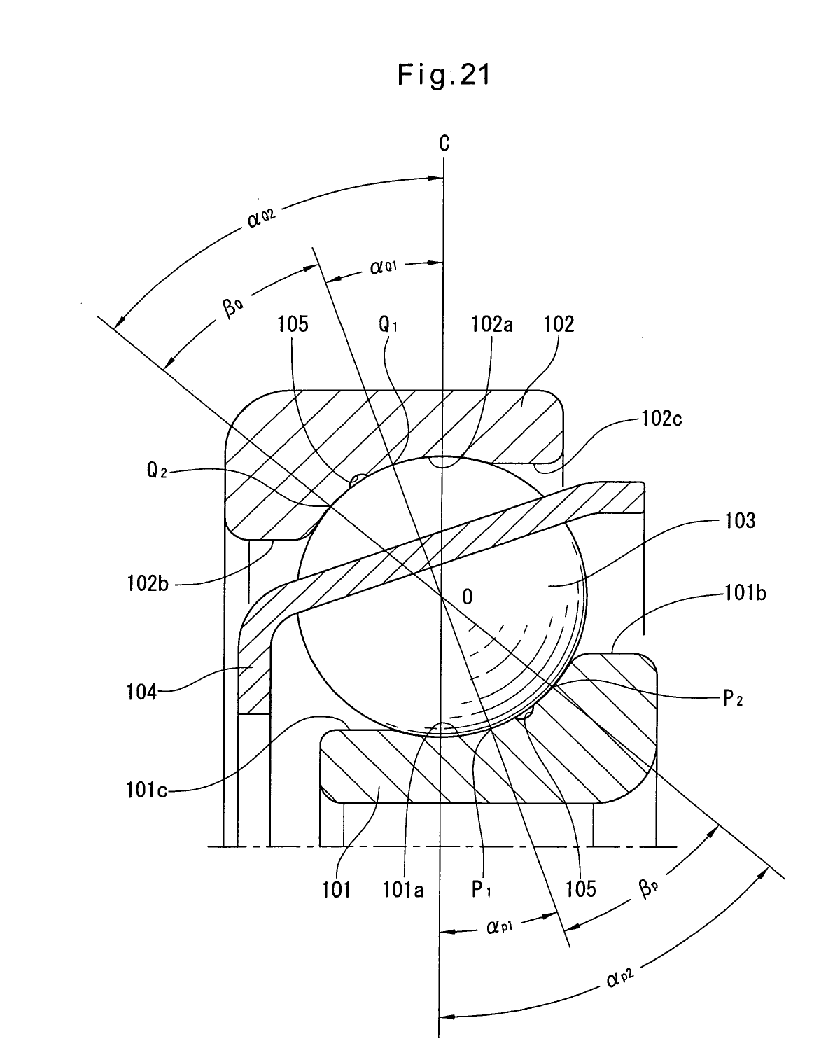

Now the 12th embodiment for achieving the sixth object is described. As shown in FIG. 21, the angular contact ball bearing according to the 12th embodiment comprises an inner ring 101 having a raceway 101a, an outer ring 102 having a raceway 102a, and a plurality of balls 103 held between the raceways 101a and 102a by a retainer 104. The inner ring 101 and the outer ring 102 have shoulders 101b and 102b, respectively, on opposite sides of the bearing centerline C that passes the center O of the bearing, and counter portions 101c and 102c, respectively, on the other sides of the respective raceways 101a and 102a.

Each ball 103 is in contact with the raceway 101a of the inner ring 101 at two contact points P₁ and P₂ that are offset toward the shoulder 101b from the bearing centerline C, at contact angles α_{P1} and α_{P2}, respectively. Similarly, each ball 103 is in contact with the raceway 102a of the outer ring 102 at two contact points Q₁ and Q₂ that are offset toward the shoulder 102b from the bearing centerline C, at contact angles α_{Q1} and α_{Q2}, respectively. In the 12th embodiment, the contact angles α_{P1} and α_{P2} on the inner ring 101 are symmetrical to and equal to the contact angles α_{Q1} and α_{Q2} on the outer ring 102, respectively, with respect to the center O of the bearing.

The spread angles β_{P} and β_{Q} between the contact angles α_{P1} and α_{P2} at the contact points P₁ and P₂ and between the contact angles α_{Q1} and α_{Q2} at the contact points Q₁ and Q₂ are both 30°. Circumferential oil grooves 105 having an arcuate section are formed in mid-portions between the contact points P₁ and P₂ and between the contact points Q₁ and Q₂, respectively.

With the angular contact ball bearing according to the 12th embodiment, the oil grooves formed in mid-portions between the respective contact points have an arcuate section. But they may have a V-shaped, square or any other section.

With angular contact ball bearing according to the 12th embodiment, each ball is in contact with each of the raceways of the inner and outer rings at two points, with the contact angles at the respective contact points on the respective raceways symmetrical to and thus equal to each other with respect to a point. But they may not necessarily be symmetrical to and equal to each other. Also, each ball may be in contact with the raceway of only one of the inner and outer rings at two points.

The angular contact ball bearing according to any of the first to 12th embodiments is not limited to the specific structure shown, but may be modified suitably unless such modification impairs any of the expected functions of the present invention.

Structural and functional features of the angular contact ball bearings according to some or all of the first to 12th embodiments may be combined. Any of the angular contact ball bearings according to the first to 12th embodiments, or any angular contact ball bearing obtained by combining two or more of the embodiments may be used as the main bearings 45 mounted in the speed reducer of the driving unit 40 for a construction vehicle, or as the main bearings 65 coupled to the output shaft 61 of the joint assembly for a robotic arm.

1. An angular contact ball bearing wherein balls are each in contact with one of raceways of an outer ring and an inner ring at two points and in contact with the other raceway at least at one point, characterized in that the contact points on said one of the raceways are offset to one axial side from a bearing centerline, that the contact point on the other of the raceways is offset to an axial side opposite to said one axial side from the bearing centerline, that one of the inner and outer rings formed with said one of the raceways has a counter portion on its axial side opposite to said one axial side, and that with each of the balls in contact with said one of the raceways at said two contact points, a gap is present between the portion of said one of the inner and outer rings at said bearing centerline and each of the balls.

2. An angular contact ball bearing wherein balls are each in contact with one of raceways of an outer ring and an inner ring at two points and in contact with the other raceway at least at one point, characterized in that the contact points on said one of the raceways are offset to one axial side from a bearing centerline, that the contact point on the other of the raceways is offset to an axial side opposite to said one axial side from the bearing centerline, and that said balls comprise ceramic balls.

3. An angular contact ball bearing wherein balls are each in contact with one of raceways of an outer ring and an inner ring at two points and in contact with the other raceway at least at one point, characterized in that the contact points on said one of the raceways are offset to one axial side from a bearing centerline, that the contact point on the other of the raceways is offset to an axial side opposite to said one axial side from the bearing centerline, and that a coating for improving wear resistance is formed on said balls.

4. A joint assembly for a robotic arm comprising a speed reducer to which driving force for moving the arm is applied, and the angular contact ball bearing of claim 2, said bearing being mounted to an output shaft of the speed reducer.

5. An angular contact ball bearing wherein balls are each in contact with respective raceways of an inner ring and an outer ring on opposite sides of a bearing centerline, and wherein the balls are in contact with at least one of the raceways at two contact points having different contact angles from each other, characterized in that the contact angle α₁ at one of the two contact points that is located closer to the bearing centerline than is the other contact point is 15 to 25°, and the contact angle α₂ at the other contact point is 40 to 50°.

6. The angular contact ball bearing of claim 5 wherein the spread angle β between the contact angles α₁ and α₂ (β=α₂−α₁) is 20° or over.

7. An angular contact ball bearing wherein balls are each in contact with respective raceways of an inner ring and an outer ring on opposite sides of a bearing centerline, and wherein the balls are in contact with at least one of the raceways at two contact points having different contact angles from each other, characterized in that said at least one of the raceways comprises two conical surfaces having different cone angles from each other, and that said two contact points are located each on one of the two conical surfaces.

8. An angular contact ball bearing wherein balls are each in contact with respective raceways of an inner ring and an outer ring on opposite sides of a bearing centerline, and wherein the balls are in contact with at least one of the raceways at two contact points having different contact angles from each other, characterized in that a circumferential oil groove is formed in said at least one of the raceways between said two contact points.

9. The angular contact ball bearing of claim 8 wherein said oil groove is formed at a mid-portion between said two contact points.

10. The angular contact ball bearing of claim 8 wherein the spread angle between the contact angles of the two contact points is 25° or over.

11. The angular contact ball bearing of claim 5 wherein the balls are each in contact with each of the raceways of the inner ring and the outer ring at two contact points.

12. A joint assembly for a robotic arm comprising a speed reducer to which driving force for moving the arm is applied, and the angular contact ball bearing of claim 3, said bearing being mounted to an output shaft of the speed reducer.

13. The angular contact ball bearing of claim 9 wherein the spread angle between the contact angles of the two contact points is 25° or over.

14. The angular contact ball bearing of claim 6 wherein the balls are each in contact with each of the raceways of the inner ring and the outer ring at two contact points.

15. The angular contact ball bearing of claim 7 wherein the balls are each in contact with each of the raceways of the inner ring and the outer ring at two contact points.

16. The angular contact ball bearing of claim 8 wherein the balls are each in contact with each of the raceways of the inner ring and the outer ring at two contact points.

17. The angular contact ball bearing of claim 9 wherein the balls are each in contact with each of the raceways of the inner ring and the outer ring at two contact points.

18. The angular contact ball bearing of claim 10 wherein the balls are each in contact with each of the raceways of the inner ring and the outer ring at two contact points.
